(19) United States
(12) Patent Application Publication
(10) Pub. No.: US 2006/0078350 A1
(43) Pub. Date: Apr. 13, 2006

(54) Color image forming apparatus

(75) Inventor: Byung-sun Ahn, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/219,692

(22) Filed: Sep. 7, 2005

(30) Foreign Application Priority Data
Oct. 11, 2004 (KR) 10-2004-0080783

(51) Int. Cl. G03G 21/18

(52) U.S. Cl. 399/111

(57) ABSTRACT

A color image forming apparatus capable of preventing an image skew by maintaining parallelism of scanning directions between respective photosensitive mediums and between the photosensitive medium and a transfer belt within a certain range. The color image forming apparatus includes an ITU/OPC cartridge, as a single unit, wherein a plurality of photosensitive mediums (OPC) and an intermediate transfer unit (ITU) are integrally mounted. In the ITU/OPC cartridge, an OPC frame and the ITU frame respectively supporting the OPC and the ITU are separably connected, so that the OPC and the ITU having different lifespan can be independently replaced.

### CROSS-REFERENCE TO RELATED APPLICATION

This application claims the benefit of Korean Patent Application No. 2004-80783, filed Oct. 11, 2004, in the Korean Intellectual Property Office, the disclosure of which is incorporated herein by reference.

### BACKGROUND OF THE INVENTION

1. Field of the Invention

The present invention relates to an image forming apparatus. More particularly, the present invention relates to a color image forming apparatus utilizing an electrophotographic process.

2. Description of Related Art

Color image forming apparatuses using an electrophotographic process, such as a copy machine, a printer and a multi-function apparatus, develop electrostatic latent images respectively formed on a plurality of photosensitive mediums by color developers to thereby form a visible image and transfer the visible image by an intermediate transfer unit or by directly transferring the visible image to a printing medium in an overlapping manner. Thus, a predetermined color image is realized.

FIG. 1 illustrates an example of a color image forming apparatus operating in the above-described manner. As shown in FIG. 1, the color image forming apparatus includes four image forming units 10 according to colors of the developer, such as yellow, magenta, cyan and black. The image forming units 10 respectively includes a photosensitive medium 11, an electrifying roller (not shown), a developing roller 12 and a developer case 13. On each photosensitive medium 11, a predetermined electrostatic latent image is formed by a laser projected from a laser scanning unit 20 provided corresponding to the photosensitive medium 11 in number. Thus-formed electrostatic latent image is developed as the visible by the developing roller 12.

The intermediate transfer unit 30 includes an intermediate transfer belt 31 moving on a caterpillar in contact with the plurality of photosensitive mediums 11, first and second rollers 32 and 33 for rotatably supporting the intermediate transfer belt 31 and a plurality of primary transfer rollers 34 mounted at an inner side of the intermediate transfer belt 31 to correspond to the photosensitive medium 11. The visible images on the respective photosensitive mediums 11 are overlappingly transferred on the intermediate transfer belt 31, thereby realizing a complete color image.

A secondary transfer roller 40 is contacted with the intermediate transfer belt 31 having a predetermined transfer nip therebetween so that the color image formed on the intermediate transfer belt 31 is transferred on a printing medium P being supplied to the transfer nip. The printing medium P is picked up from a paper supply cassette 51 provided to a main body 50 of the image forming apparatus by a pickup roller 52 and supplied to the transfer nip.

A fixing unit 60 applies heat and pressure to the printing medium P passed through the transfer nip to fuse the color image on the printing medium P. Then, the printing medium P is discharged to a discharged paper tray 90 by a transfer roller 70 and a discharge roller 80.

FIG. 2 schematically shows another example of a conventional color image forming apparatus. Compared to the former color image forming apparatus shown in FIG. 1, the color image forming apparatus of FIG. 2 passes the printing medium P through a space between a belt unit 30′ and the photosensitive medium 11 without the secondary transfer roller 40 and directly transfers the visible image formed on the photosensitive medium 11 onto the printing medium P using high voltage; however, the other structures thereof are the same as the former example of the color image forming apparatus. Therefore, it will be understood that like reference numerals refer to like features and structures, and the like structures will not be described in detail hereinbelow.

In the color image forming apparatus shown in FIG. 1, the intermediate transfer unit 30 and the photosensitive medium 11 are separated. The photosensitive medium 11, being formed integrally with a developing unit, constructs the image forming unit 10. The intermediate unit 30 and the image forming unit 10 are driven by respectively dedicated driving sources. The color image forming apparatus of FIG. 2 also separately has the belt unit 30′ and the photosensitive medium 11. The image forming unit 10 is constructed by the photosensitive medium 11 and a developing unit which are integrally formed and driven by respectively dedicated driving sources.

In the above-structured color image forming apparatuses, it is required that the intermediate transfer unit 30 (or the belt unit 30′), the photosensitive unit 11 and the respective image forming units 10 and the laser scanning units 20 are arranged exactly parallel with one another, such that the processes of laser-scanning, developing and image-transferring are concurred in embodying the plurality of colors, and accordingly high quality of the color image can be realized.

However, in the conventional color image forming apparatuses, the intermediate transfer unit 30 (or the belt unit 30′) and the photosensitive unit 11 are separately disposed and also separately assembled from their own positions in the main body 50 with reference to respectively different mounting positions. Accordingly, an assembling error may be generated, thereby breaking the parallelism among the photosensitive medium 11, the intermediate transfer unit 30 (or the belt unit 30′) and the transfer rollers 34′ and accordingly causing an image skew as shown in FIG. 3. The image skew can be a main factor preventing accurate development of colors.

Reference symbols A, B, C and D in FIG. 3 denote an image line transferred from the respective photosensitive mediums 11 onto the intermediate transfer unit 30 or the printing medium P. The image lines are supposed to be transferred from the four photosensitive mediums 11 and overlapped as one line; however, the broken parallelism, caused by the assembling error between the intermediate transfer unit 30 or the belt unit 30′ and the photosensitive mediums 11, induces the skews S1 and S2 of FIG. 3, which is the main cause of inferior image formation.

Furthermore, the photosensitive unit 11 is costly and has a relatively longer lifespan than the developing unit. However, since the image forming unit 10 of the conventional color image forming apparatus integrally includes the photosensitive unit 11 and the developing unit, the lifespan of the photosensitive unit is determined by an amount of toner of the developing unit. As a result, cost for maintenance increases.

### BRIEF SUMMARY

An aspect of the present invention provides a color image forming apparatus capable of preventing an image skew by maintaining parallelism of scanning directions between respective photosensitive mediums and between the photosensitive medium and a belt within a certain range.

Another aspect of the present invention provides a color image forming apparatus implementing reduction of maintenance cost by separately replacing parts, such as the photosensitive medium, a belt unit and a developing unit, having different lifespan, respectively.

According to an aspect of the present invention, there is provided a color image forming apparatus including: at least one photosensitive medium (OPC) forming thereon an electrostatic latent image; a developing unit developing the electrostatic latent image on the photosensitive medium by a developer into a visible image; and a transfer unit transferring the visible image onto a printing medium. The at least one photosensitive medium and the transfer unit are in a cartridge as a single unit.

According to another aspect of the present invention, there is provided a color image forming apparatus comprising: at least one photosensitive medium (OPC) forming thereon an electrostatic latent image; a developing unit developing the electrostatic latent image on the photosensitive medium by a developer into a visible image; and an intermediate transfer unit (ITU) having a transfer belt moving on a caterpillar in contact with the photosensitive medium. The at least one photosensitive medium and the intermediate transfer unit are in an ITU/OPC cartridge as a single unit.

The ITU/OPC cartridge may include an OPC frame for supporting the photosensitive medium; an ITU frame detachably mounted to the OPC frame to support the intermediate transfer unit; a hinge unit serving as a reference position for connection and separation of the OPC frame and the ITU frame; and a locking unit for maintaining the connection between the ITU frame and the OPC frame.

The OPC frame may include an electrifying roller for electrically charging the photosensitive medium, a cleaning member for removing waste toner remaining on the photosensitive medium, and a waste toner receptacle for storing the waste toner removed by the cleaning member.

The intermediate transfer unit may include a transfer belt; first through third rollers for ratably supporting the transfer belt; and a plurality of primary transfer rollers mounted at an inner side of the transfer belt to correspond to the photosensitive mediums.

The color image forming apparatus may include first and second photosensitive mediums; first and second laser scanning units for applying a laser beam onto the first and the second photosensitive mediums to form an electrostatic latent image; and four developing units for developing the electrostatic latent images on the first and the second photosensitive mediums by developers according to colors, and two of the four developing units are disposed to develop the electrostatic latent image on the first photosensitive medium and the other two developing units are disposed to develop the electrostatic latent image on the second photosensitive medium.

The color image forming apparatus may include a first driving source for operating the first and the second photosensitive mediums and the transfer belt of the intermediate transfer unit; and a second driving source for operating the developing units.

Power of the second driving source may be transmitted to the respective developing units through a power conversion clutch. The second driving source may be provided in the number for independently driving the respective developing units.

The two developing units for developing the electrostatic latent image on the first photosensitive medium may be yellow and cyan developing units, and the other two developing for developing the electrostatic latent image on the second photosensitive medium are magenta and black developing units.

According to another aspect of the present invention, there is provided a color image forming apparatus including: a main body having a front door and an upper door pivoting in an opening and closing manner; an intermediate transfer unit/photosensitive medium (ITU/OPC) cartridge comprising at least one photosensitive medium and an intermediate transfer unit having a transfer belt moving on a caterpillar in contact with the at least one photosensitive medium as a single unit, and removably mounted through an opening opened and closed by the upper door of the main body; a laser scanning unit forming a predetermined electrostatic latent image by applying a laser beam on the at least one photosensitive medium; a developing unit developing the electrostatic latent image on the photosensitive medium by developers according to colors into a visible image; a secondary transfer roller circumscribed with the transfer belt and transferring the visible image overlapped on the transfer belt onto the printing medium; a feeding unit supplying the printing medium to a transfer nip between the secondary transfer roller and the transfer belt; and a fixing unit fixing the visible image onto the printing medium by applying heat and pressure to the printing medium passed through the transfer nip.

The ITU/OPC cartridge may include an OPC frame for supporting the photosensitive medium; an ITU frame detachably mounted to the OPC frame to support the intermediate transfer unit; a hinge unit serving as a reference position for connection and separation of the OPC frame and the ITU frame; and a locking unit for maintaining the connection between the ITU frame and the OPC frame.

The OPC frame may include an electrifying roller for electrically charging the photosensitive medium, a cleaning member for removing waste toner remaining on the photosensitive medium, and a waste toner receptacle for storing the waste toner removed by the cleaning member.

The intermediate transfer unit may include the transfer belt; first through third rollers for ratably supporting the transfer belt; and a plurality of primary transfer rollers mounted at an inner side of the transfer belt to correspond to the photosensitive mediums.

The color image forming apparatus may include first and second photosensitive mediums; first and second laser scanning units; and four developing units. Two of the four developing units may be disposed to develop the electrostatic latent image on the first photosensitive medium and the other two developing units may be disposed to develop the electrostatic latent image on the second photosensitive medium.

The respective developing units may be mounted in the main body to move between a first position and a second position, the first position one at which the electrostatic latent images on the first and the second photosensitive mediums are developed and the second position one at which the developing unit retreats toward the laser scanning unit by a certain distance in order not to obstruct separation or connection of the ITU/OPC cartridge with respect to the main body, and the developing units may move between the first and the second positions in association with opening and closing of the front door of the main body.

An order of opening the front door and the upper door of the main body may be fixed so that the upper door can be opened only when the front door is opened, and the front door can be closed only after the front door is closed.

Still another aspect of the present invention provides a color image forming apparatus including: a main body having a front door and an upper door pivoting in an opening and closing manner; an intermediate transfer unit/photosensitive medium (ITU/OPC) cartridge comprising at least one photosensitive medium and a transfer unit having a belt moving on a caterpillar in contact with the at least one photosensitive medium as a single unit, and removably mounted through an opening opened and closed by the upper door of the main body; a laser scanning unit forming a predetermined electrostatic latent image by applying a laser beam on the at least one photosensitive medium; a developing unit developing the electrostatic latent image on the at least one photosensitive medium by developers according to colors into a visible image; a feeding unit supplying the printing medium to a space between the belt and the photosensitive medium; and a fixing unit fixing the visible image onto the printing medium by applying heat and pressure to the printing medium passed through the transfer nip.

The transfer unit may include a belt for moving the printing medium; first through third rollers for ratably supporting the belt; and a plurality of transfer rollers mounted at an inner side of the belt to correspond to the photosensitive mediums.

The ITU/OPC cartridge may include an OPC frame for supporting the photosensitive medium; an ITU frame detachably mounted to the OPC frame to support the transfer unit; a hinge unit serving as a reference position for connection and separation of the OPC frame and the ITU frame; and a locking unit for maintaining the connection between the ITU frame and the OPC frame.

According to another aspect of the present invention, there is provided a driving system of the color image forming apparatus, including: a first motor operating first and second photosensitive mediums and a transfer belt of an intermediate transfer unit; a second motor operating plural developing units; and a power conversion clutch transmitting the power of the second motor to respective ones of the plural developing units.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which;

FIG. 1 shows an example of general color image forming apparatus;

FIG. 2 shows another example of general color image forming apparatus;

FIG. 3 shows an example of image skews generated in the general color image forming apparatuses shown in FIGS. 1 and 2;

FIG. 4 schematically shows a color image forming apparatus according to an embodiment of the present invention;

FIG. 5 is a perspective view of a main body frame of the color image forming apparatus according to an embodiment of the present invention;

FIG. 6 is a perspective view of the color image forming apparatus according to an embodiment of the present invention with a front door opened;

FIG. 7 shows the front door and an upper door of the color image forming apparatus according to an embodiment of the present invention, being in an open state;

FIG. 8 schematically shows an ITU/OPC (intermediate transfer unit/organic photoconductor) cartridge which is an essential part of the color image forming apparatus according to an embodiment of the present invention;

FIG. 9 is an exploded, perspective view of the ITU/OPC cartridge of FIG. 8;

FIG. 10 is a perspective view showing processes for connecting the ITU/OPC cartridge of FIG. 9;

FIG. 11 is a perspective view of the ITU/OPC cartridge as being connected; and

FIG. 12 is a flowchart for explaining the operation for driving the color image forming apparatus according to an embodiment of the present invention.

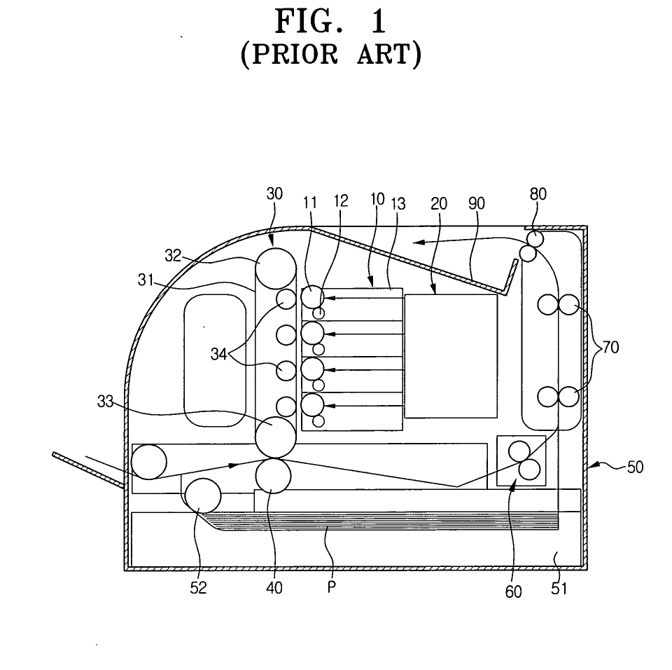

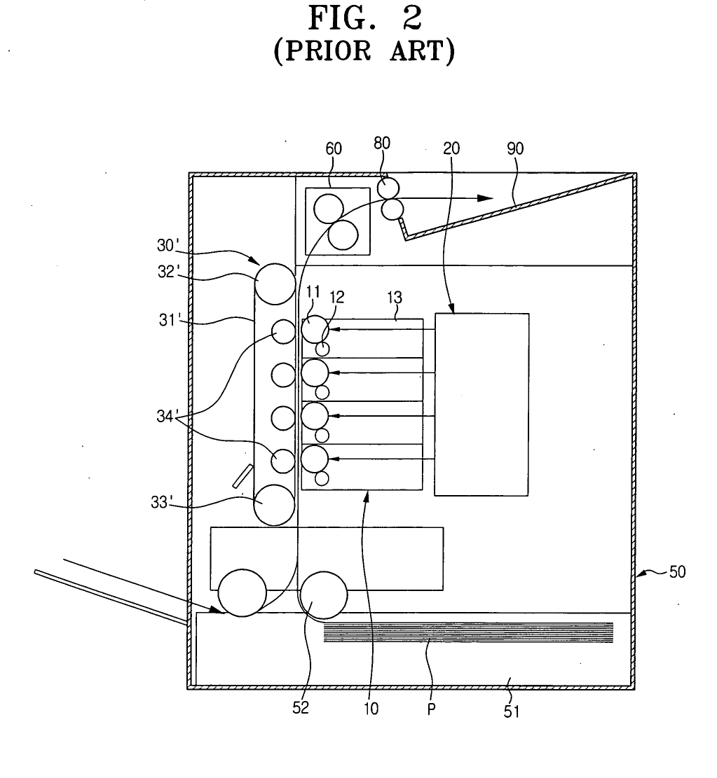

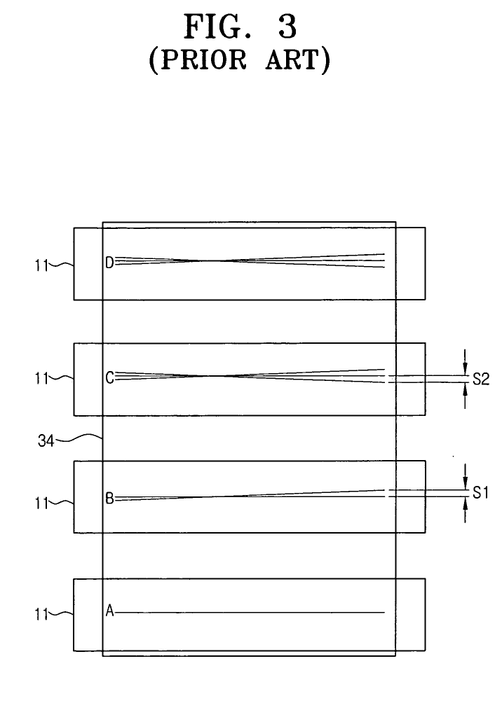

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

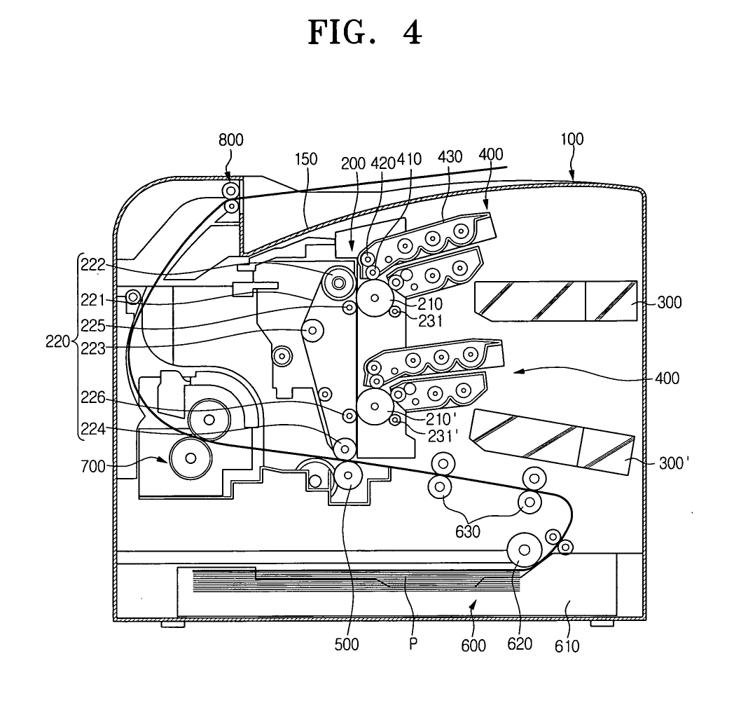

Referring to FIG. 4, a color image forming apparatus according to an embodiment of the present invention includes a main body 100, an ITU/OPC (intermediate transfer unit/organic photoconductor) cartridge 200, a laser scanning unit 300 and 300′, four developing units 400 for four colors, a secondary transfer roller 500, a feeding unit 600, a fixing unit 700 and a discharge unit 800.

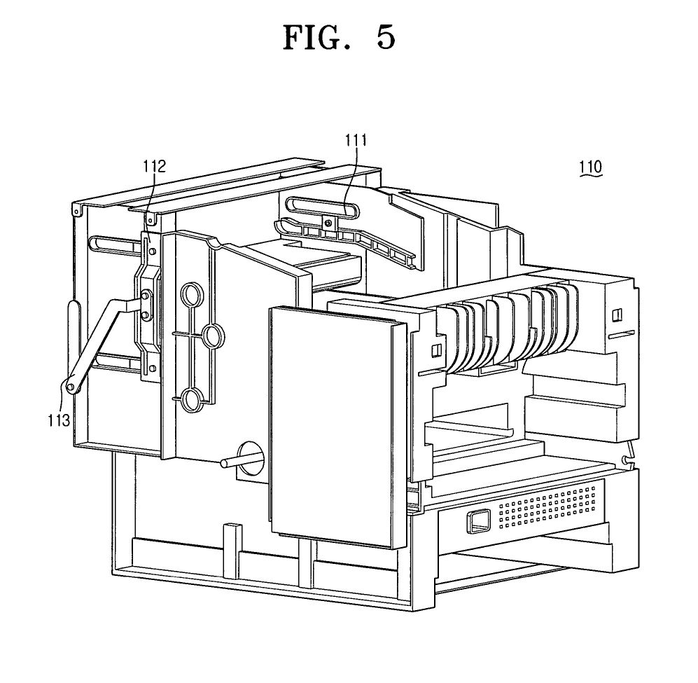

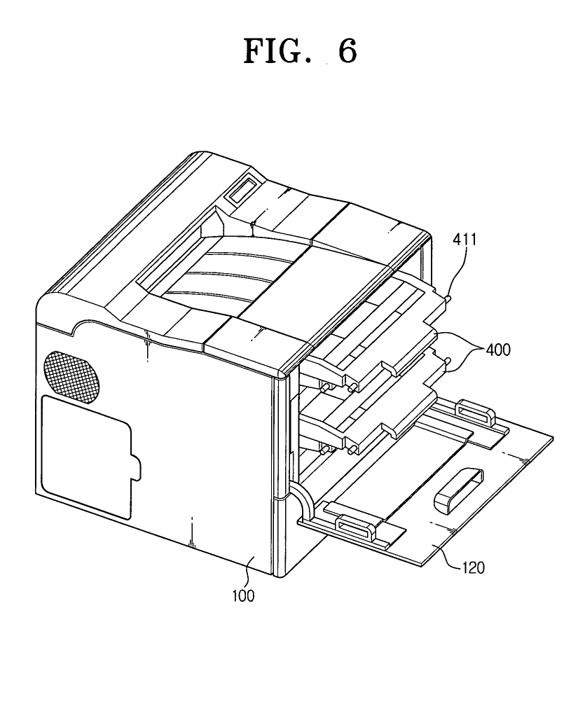

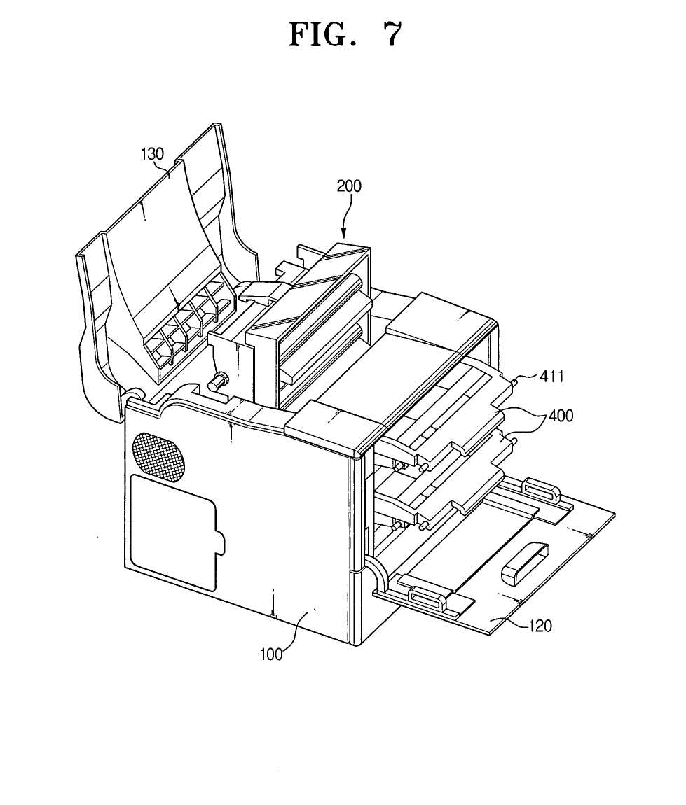

As shown in FIGS. 5 to 7, the main body 100 includes a main body frame 110 for encasing therein the above component parts, that is, the ITU/OPC cartridge 200, the laser scanning unit 300 and 300′, the four developing units 400, the secondary transfer roller 500, the feeding unit 600, the fixing unit 700 and the discharge unit 800. In addition, the main body 100 includes a front door 120 and an upper door 130 formed at a front side and a top side thereof, respectively, to selectively expose the component parts as necessary.

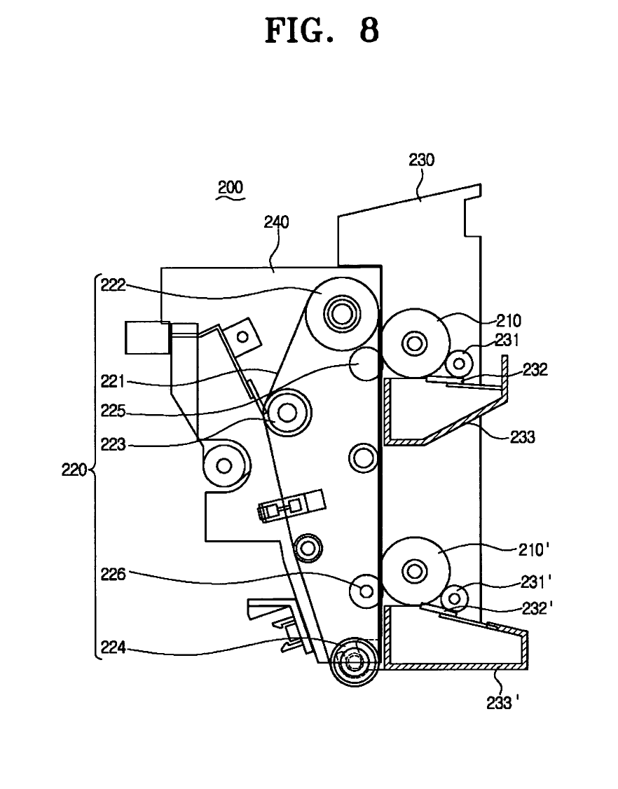

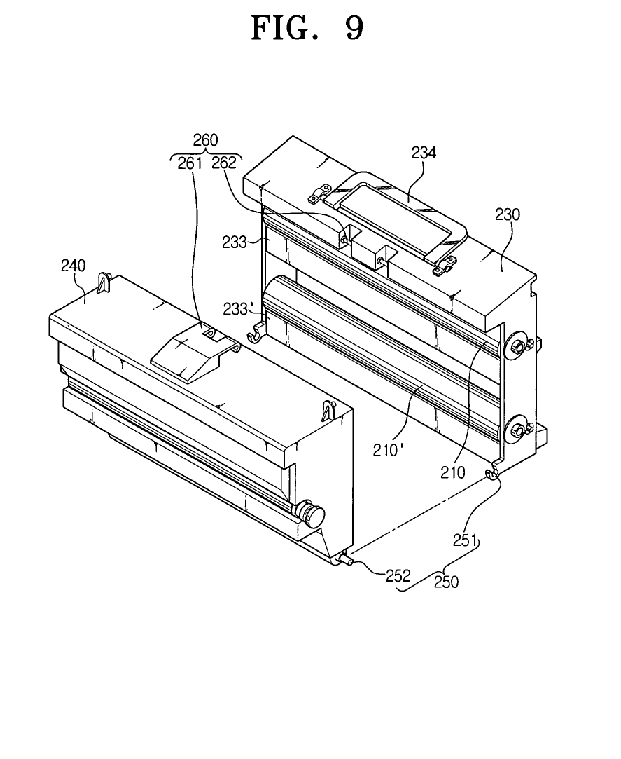

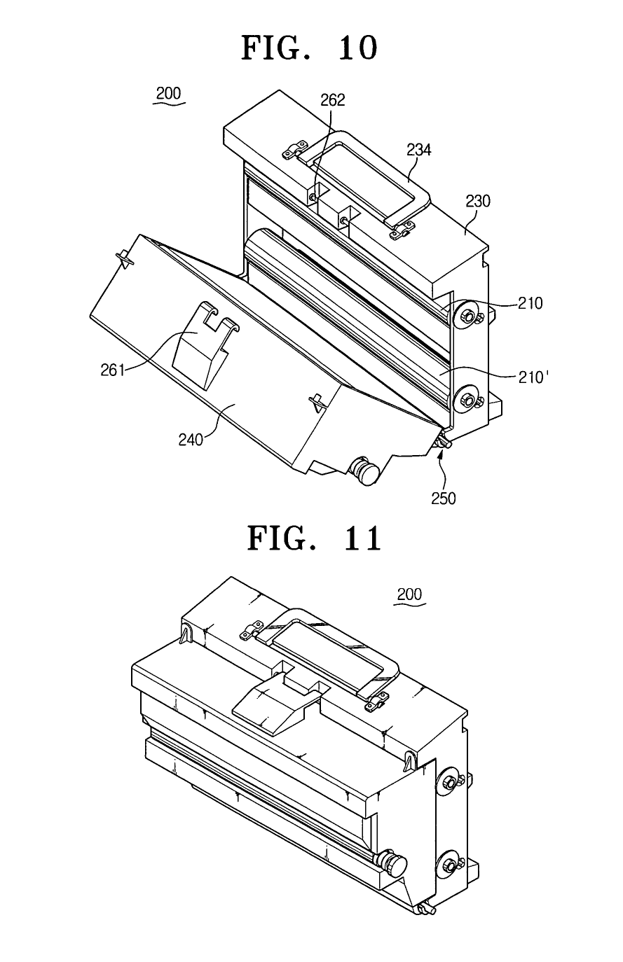

The ITU/OPC cartridge 200 includes, as a single unit, one or more photosensitive mediums (OPC) and an intermediate transfer unit (ITU) 220 for transferring an image from the photosensitive mediums. In this embodiment, first and second photosensitive mediums 210 and 210′ are provided. As shown in FIGS. 8 through 11, the ITU/OPC cartridge 200 includes an OPC frame 230, an ITU frame 240, a hinge unit 250 and a locking unit 260.

The OPC frame 230 rotatably supports the first and the second photosensitive mediums 210 and 210′. Further, the OPC frame 230 includes first and second electrifying rollers 231 and 231′ for electrically charging the first and the second photosensitive mediums 210 and 210′, first and second cleaning members 232 and 232′ for removing waste toner remaining on the first and the second photosensitive mediums 210 and 210′, and first and second waste toner receptacles 233 and 233′ for storing the waste toner removed by the cleaning members 232 and 232′. In addition, a handle 234 is further provided to facilitate handling of the OPC frame 230.

The ITU frame 240 is detachably mounted to the OPC frame 230 and supports the intermediate transfer unit 220. The intermediate transfer unit 220 includes a transfer belt 221 moving on a caterpillar in contact with the first and the second photosensitive mediums 210 and 210′, first to third rollers 222, 223 and 224 for supporting the transfer belt 221, and first and second primary transfer rollers 225 and 226 formed on an inner side of the transfer belt 221 to correspond to the first and the second photosensitive mediums 210 and 210′. Although the present embodiment adopts the three rollers 222, 223 and 234 to support the caterpillar movement of the transfer belt 221, only two rollers can be used to do the same.

The hinge unit 250 includes hinge holes 251 formed on opposite sides of the OPC frame 230 and hinge shafts 252 formed on the ITU frame 240 to correspond to the hinge holes 251 in order to serve as a reference mounting position for connection and separation between the OPC frame 230 and the ITU frame 240. However, it is to be understood that the hinge unit 250 is not limited to this non-limiting example but may be implemented in various other manners. For example, positions of the hinge holes and the hinge shafts may be exchanged. Also, a shaft of the second photosensitive medium 210′ may be used as the hinge shaft while providing a hinge bracket having the hinge hole for receiving the shaft to the ITU frame 240.

The locking unit 260 keeps connection between the OPC frame 230 and the ITU frame 240. For this purpose, the locking unit 260 includes a locker 261 formed on the ITU frame 240 and a locking projection 262 formed on the OPC frame 230 corresponding to the locker 261. Locations of the locker 261 and the locking projection 262 may be exchanged.

The above-structured ITU/OPC cartridge 200 is mounted in the main body 100 of the image forming apparatus in a manner that one of the shafts of the first and the second photosensitive mediums 210 and 210′ is fit in the reference mounting position formed in the main body 100. Compared to the conventional image forming apparatus wherein the intermediate transfer unit and the photosensitive medium are separately formed and mounted to the main body based on their own reference mounting position, respectively, the ITU/OPC cartridge 200 according to an embodiment of the present invention is able to mount the intermediate transfer unit and the photosensitive medium to the main body 100, thereby generating almost no assembling error. The shaft of the second photosensitive medium 210′ of the ITU/OPC cartridge 200 may be adapted to the reference mounting position of the main body 100 of the image forming apparatus.

Accordingly, parallelism between the photosensitive medium and the transfer belt and between the photosensitive medium and the primary transfer roller can be constantly maintained, thereby preventing occurrence of an image skew and improving color superposition.

Additionally, because the OPC frame 230 and the ITU frame 240 are separably mounted in the ITU/OPC cartridge 200 according to an embodiment of the present invention, when any one of the OPC frame 230 and the ITU frame 240 of which lifespans are different is exhausted, only one thereof may be replaced. Accordingly, maintenance cost can be saved.

The laser scanning unit 300 applies a laser beam to form an electrostatic latent image on the first and the second photosensitive mediums 210 and 210′. Therefore, the laser scanning unit 300 includes first and second laser scanning units 300 and 300′ corresponding to the first and the second photosensitive mediums 210 and 210′.

The developing unit 400 develops the electrostatic latent image formed on the photosensitive mediums 210 and 210′ by respective color developers, thereby generating a visible image. In this embodiment, four colors of developers, that is, yellow, magenta, cyan and black, are used. Each developing unit 400 includes a developing roller 410, a developer supplying roller 420 and a developer case 430. Two of the developing units 400, for example, the developing units 400 for yellow and cyan are disposed to develop the electrostatic latent image of the first photosensitive medium 210, while the other two developing units 400, for example, the developing units 400 for magenta and black are disposed to develop the electrostatic latent image of the second photosensitive medium 210′.

Meanwhile, in the color image forming apparatus according to an embodiment of the present invention, the developing unit 400 is mounted to the main body 100 to move between a first position and a second position. In the first position, the electrostatic latent images on the first and the second photosensitive mediums 210 and 210′ are developed. In the second position, the developing unit 400 retreats toward the laser scanning unit 300 by a certain distance in order not to obstruct separation or connection of the ITU/OPC cartridge 200 with respect to the main body 100. Also, the developing unit 400 moves between the first and the second positions in association with opening and closing of the front door 120 of the main body 100.

To this end, as shown in FIG. 5, the main body frame 110 includes guide rails 111 on opposite sides thereof, so that the guide rails 111 slide with guide projections 411 formed on both sides of the developing unit 400 inserted therein. The main body frame 110 further includes sliders 112 for moving along the guide rails 111. The sliders 112 are connected to the front door 120 by a link 113. As the front door 120 is opened and closed, the developing unit 400 moves to the second position and to the first position, respectively.

According to an embodiment of the present invention, an order of opening the front door 120 and the upper door 130 of the main body 100 is fixed. More specifically, when the front door 120 is closed, the upper door 130 cannot be opened. Also, the front door 120 can be closed only after the upper door 130 is closed. As a result, when mounting or separating the ITU/OPC cartridge 200 with respect to the main body 100, the ITU/OPC cartridge 200 and the developing unit 400 do not interrupt each other. Such a structure can prevent a user from unconsciously mounting or separating the ITU/OPC cartridge 200 with respect to the main body 100 with only the upper door 130 opened.

The visible images on the first and the second photosensitive mediums 210 and 210′ developed by the developing unit 400 according to the respective colors are transferred in an overlapping manner onto the transfer belt 221 which moves on a caterpillar in contact with the photosensitive mediums 210, thereby obtaining a complete color image on the transfer belt 221.

The secondary transfer roller 500 is circumscribed with the transfer belt 221, such that the color image of the transfer belt 221 is transferred onto a printing medium P entering a transfer nip between the transfer belt 221 and the second transfer roller 500.

The feeding unit 600 supplies the printing medium P to the transfer nip and includes a paper supply cassette 610, a pickup roller 620 for picking up the printing medium P on the paper supply cassette 610, and a plurality of feeding rollers 630 for transferring the picked-up printing medium P.

The fixing unit 700 is disposed at a lower stream of the secondary transfer roller 50 with respect to a moving direction of the printing medium P to fix the image on the printing medium P by applying heat and pressure to the printing medium P.

The discharge unit 800 finally discharges the printing medium P passed through the fixing unit 700 to the discharge paper tray 150.

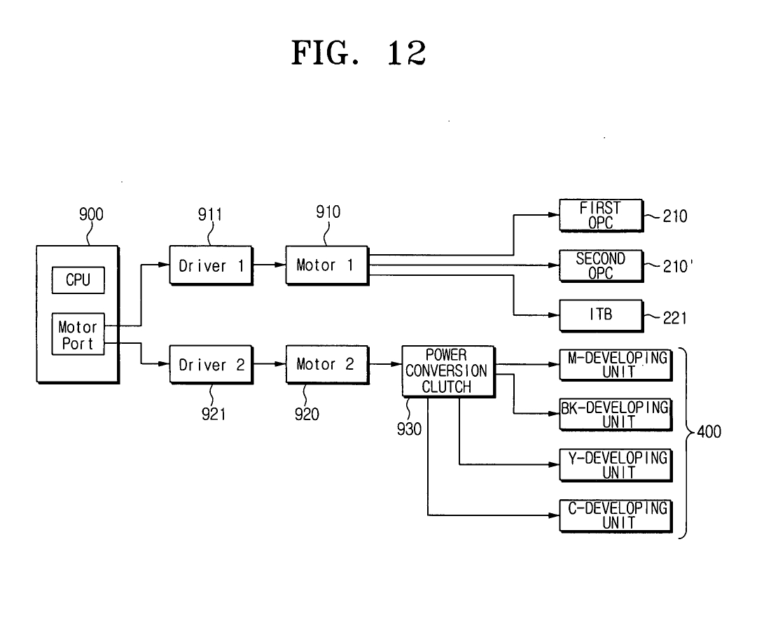

As shown in FIG. 12, a driving system of the color image forming apparatus is divided into a first motor 910 for operating the first and the second photosensitive mediums 210 and 210′ and the transfer belt 221 of the intermediate transfer unit 220, and a second motor 920 for operating the respective developing units 400. This structure helps minimize transmission of vibration or impact between the photosensitive mediums 210 and 210′ and the developing units 400. In FIG. 12, a reference numeral 900 denotes a control part, 911 and 921 motor driving parts, and 930 a power conversion clutch.

Power of the second motor 920 is transmitted to the respective developing units 400 through the power conversion clutch 930. Although not shown, the second motor 920 may be provided corresponding to the number of the developing units 400, so as to independently operate the respective developing units 400.

In the above-structured color image forming apparatus, a predetermined laser beam is scanned from the laser scanning units 300 and 300′ onto the photosensitive mediums 210 and 210′ electrically charged by the electrifying roller 231 and 231′, thereby forming the electrostatic latent image according to data of a desired image.

The electrostatic latent images are developed by the plurality of developing units 400. In the color image forming apparatus wherein two developing units are allocated for one electrostatic latent image, the image forming processes are as follows.

A yellow image is developed on the first photosensitive medium 210 and a magenta image on the second photosensitive medium 210′, and the developed images are overlappingly transferred on the intermediate transfer belt 221. When the overlapped image reaches the first photosensitive medium 210 after the intermediate transfer belt 221 rotates once, a cyan image which is already developed is transferred. After a predetermined time interval, a black image developed on the second photosensitive medium 210′ is overlappingly transferred.

According to an embodiment of the present invention, because the transfer belt, the primary transfer roller and the photosensitive medium are included in a cartridge as a single unit, parallelism between the parts, that is, between the transfer belt and the photosensitive medium and between the primary transfer roller and the photosensitive mediums can be constantly maintained. Accordingly, image skews can be improved while color superposition is improved.

Thus-completed color image transferred onto the transfer belt 221 is secondarily transferred by the secondary transfer roller 500 onto the printing medium P supplied to the transfer nip between the transfer belt 221 and the secondary transfer roller 500. The printing medium P transferred with the color image is passed through the fixing unit 700 and finally discharged by the discharge unit 800 to the discharged paper tray 150.

Although the image forming apparatus including a pair of photosensitive mediums has been described according to an embodiment of the present invention, it is to be understood that the present invention is applicable to other image forming apparatuses having four photosensitive mediums and corresponding developing units to achieve the same object and effect. Moreover, the image forming apparatus of the embodiment of the present invention includes a transfer belt and a secondary transfer roller; however, the image forming apparatus may directly transfer the color image in an overlapping manner by transferring the printing medium between a belt and the photosensitive medium without comprising a dedicated secondary transfer roller.

As can be appreciated from the above description of the present invention, parallelism between the transfer belt and the photosensitive medium and between the primary transfer roller and the photosensitive medium can be regulated or maintained within a certain range. As a result, generation of an image skew can be restrained, thereby considerably improving color superposition. Accordingly, quality of color and image can be enhanced.

Also, embodiments of the present invention enable independent replacement of the photosensitive medium and the intermediate transfer unit, which have different lifespans, thereby saving maintenance cost compared to the conventional image forming apparatus having an image forming unit integrally having the photosensitive medium and the developing unit.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A color image forming apparatus comprising:
at least one photosensitive medium (OPC) forming thereon an electrostatic latent image;
a developing unit developing the electrostatic latent image on the photosensitive medium by a developer into a visible image; and
a transfer unit transferring the visible image onto a printing medium,
wherein the at least one photosensitive medium and the transfer unit are in a cartridge as a single unit.

2. A color image forming apparatus comprising:
at least one photosensitive medium (OPC) forming thereon an electrostatic latent image;
a developing unit developing the electrostatic latent image on the photosensitive medium by a developer into a visible image; and
an intermediate transfer unit (ITU) having a transfer belt moving on a caterpillar in contact with the photosensitive medium,
wherein the at least one photosensitive medium and the intermediate transfer unit are in an ITU/OPC cartridge as a single unit.

3. The color image forming apparatus of claim 2, wherein the ITU/OPC cartridge comprises:
an OPC frame supporting the photosensitive medium;
an ITU frame detachably mounted to the OPC frame and supporting the intermediate transfer unit;
a hinge unit serving as a reference position for connection and separation of the OPC frame and the ITU frame; and
a locking unit maintaining a connection between the ITU frame and the OPC frame.

4. The color image forming apparatus of claim 3, wherein the OPC frame comprises:
an electrifying roller electrically charging the photosensitive medium;
a cleaning member removing waste toner remaining on the photosensitive medium; and
a waste toner receptacle storing the waste toner removed by the cleaning member.

5. The color image forming apparatus of claim 3, wherein the at least one photosensitive medium is more than one, and
wherein the intermediate transfer unit (ITU) comprises:
the transfer belt;
first through third rollers rotatably supporting the transfer belt; and
a plurality of primary transfer rollers mounted at an inner side of the transfer belt and corresponding to the photosensitive mediums.

6. The color image forming apparatus of claim 2, comprising:
first and second photosensitive mediums;
first and second laser scanning units respectively applying a laser beam onto the first and the second photosensitive mediums to form an electrostatic latent image on each of the first and the second photosensitive mediums; and
four developing units developing the electrostatic latent images on the first and the second photosensitive mediums by developers according to colors,
wherein two of the four developing units develop the electrostatic latent image on the first photosensitive medium and the other two developing units develop the electrostatic latent image on the second photosensitive medium.

7. The color image forming apparatus of claim 6, comprising:
a first driving source operating the first and the second photosensitive mediums and the transfer belt of the intermediate transfer unit; and
a second driving source operating the developing units.

8. The color image forming apparatus of claim 7, wherein power of the second driving source is transmitted to the respective developing units through a power conversion clutch.

9. The color image forming apparatus of claim 6, wherein the two developing units for developing the electrostatic latent image on the first photosensitive medium are yellow and cyan developing units, and the other two developing for developing the electrostatic latent image on the second photosensitive medium are magenta and black developing units.

10. A color image forming apparatus comprising:
a main body having a front door and an upper door pivoting in an opening and closing manner;
an intermediate transfer unit/photosensitive medium (ITU/OPC) cartridge comprising at least one photosensitive medium and an intermediate transfer unit having a transfer belt moving on a caterpillar in contact with the at least one photosensitive medium as a single unit, and removably mounted through an opening opened and closed by the upper door of the main body;
a laser scanning unit forming a predetermined electrostatic latent image by applying a laser beam on the at least one photosensitive medium;
a developing unit developing the electrostatic latent image on the photosensitive medium by developers according to colors into a visible image;
a secondary transfer roller circumscribed with the transfer belt and transferring the visible image overlapped on the transfer belt onto the printing medium;
a feeding unit supplying the printing medium to a transfer nip between the secondary transfer roller and the transfer belt; and
a fixing unit fixing the visible image onto the printing medium by applying heat and pressure to the printing medium passed through the transfer nip.

11. The color image forming apparatus of claim 10, wherein the ITU/OPC cartridge comprises:
an OPC frame supporting the photosensitive medium;
an ITU frame detachably mounted to the OPC frame and supporting the intermediate transfer unit;
a hinge unit serving as a reference position for a connection and separation of the OPC frame and the ITU frame; and
a locking unit maintaining the connection between the ITU frame and the OPC frame.

12. The color image forming apparatus of claim 11, wherein the OPC frame comprises:
an electrifying roller for electrically charging the photosensitive medium;
a cleaning member for removing waste toner remaining on the photosensitive medium; and
a waste toner receptacle for storing the waste toner removed by the cleaning member.

13. The color image forming apparatus of claim 11, wherein the at least one photosensitive medium is more than one, and
wherein the intermediate transfer unit comprises:
the transfer belt;
first through third rollers rotatably supporting the transfer belt; and
a plurality of primary transfer rollers mounted at an inner side of the transfer belt and corresponding to the photosensitive mediums.

14. The color image forming apparatus of claim 10, comprising:
first and second photosensitive mediums;
first and second laser scanning units; and
four developing units,
wherein two of the four developing units develop the electrostatic latent image on the first photosensitive medium and the other two developing units develop the electrostatic latent image on the second photosensitive medium.

15. The color image forming apparatus of claim 14, wherein the respective developing units are mounted in the main body and move between a first position and a second position, the first position being one at which the electrostatic latent images on the first and the second photosensitive mediums are developed and the second position being one at which the developing units retreat toward the laser scanning units by a certain distance in order not to obstruct separation or connection of the ITU/OPC cartridge with respect to the main body, and
wherein the developing units move between the first and the second positions in association with opening and closing of the front door of the main body.

16. The color image forming apparatus of claim 15, wherein an order of opening the front door and the upper door of the main body is fixed such that the upper door can be opened only when the front door is opened, and the front door can be closed only after the front door is closed.

17. The color image forming apparatus of claim 14, comprising:
a first driving source operating the first and the second photosensitive mediums and the transfer belt of the intermediate transfer unit; and
a second driving source operating the developing units.

18. The color image forming apparatus of claim 17, wherein power of the second driving source is transmitted to the respective developing units through a power conversion clutch.

19. The color image forming apparatus of claim 14, wherein the two developing units developing the electrostatic latent image on the first photosensitive medium are yellow and cyan developing units, and the other two developing developing the electrostatic latent image on the second photosensitive medium are magenta and black developing units.

20. A color image forming apparatus comprising:
a main body having a front door and an upper door pivoting in an opening and closing manner;
an intermediate transfer unit/photosensitive medium (ITU/OPC) cartridge comprising at least one photosensitive medium and a transfer unit having a belt moving on a caterpillar in contact with the at least one photosensitive medium as a single unit, and removably mounted through an opening opened and closed by the upper door of the main body;
a laser scanning unit forming a predetermined electrostatic latent image by applying a laser beam on the at least one photosensitive medium;
a developing unit developing the electrostatic latent image on the at least one photosensitive medium by developers according to colors into a visible image;
a feeding unit supplying the printing medium to a space between the belt and the photosensitive medium; and
a fixing unit fixing the visible image onto the printing medium by applying heat and pressure to the printing medium passed through the transfer nip.

21. The color image forming apparatus of claim 20, wherein the at least one photosensitive medium is more than one, and
wherein the transfer unit comprises:
the belt feeding the printing medium;
first through third rollers rotatably supporting the belt; and
a plurality of transfer rollers mounted at an inner side of the belt and corresponding to the photosensitive mediums.

22. The color image forming apparatus of claim 21, wherein the ITU/OPC cartridge comprises:
an OPC frame supporting the photosensitive medium;
an ITU frame detachably mounted to the OPC frame to support the transfer unit;
a hinge unit serving as a reference position for connection and separation of the OPC frame and the ITU frame; and
a locking unit maintaining a connection between the ITU frame and the OPC frame.

23. A driving system of the color image forming apparatus, comprising:
a first motor operating first and second photosensitive mediums and a transfer belt of an intermediate transfer unit;
a second motor operating plural developing units; and
a power conversion clutch transmitting the power of the second motor to respective ones of the plural developing units.
